(19) United States
(12) Patent Application Publication
(10) Pub. No.: US 2015/0333959 A1
(43) Pub. Date: Nov. 19, 2015

(54) METHOD AND SYSTEM FOR DEVICE MANAGEMENT

(71) Applicant: Agreeya Mobility, Inc.

(72) Inventors: Chirag Pathak, Burnaby (CA); Ashwini Bharadwaj, Burnaby (CA); Bernard Wei, Burnaby (CA); Thomas Winkler, Burnaby (CA); Pankaj Thapa, Mountain View, CA (US)

(21) Appl. No.: 14/712,060

(22) Filed: May 14, 2015

Related U.S. Application Data
(60) Provisional application No. 61/993,100, filed on May 14, 2014.

(51) Int. Cl. H04L 12/24; H04L 29/06; G06F 9/445

(52) U.S. Cl. CPC H04L 41/0806; G06F 8/61; H04L 63/08; H04W 88/02

(57) ABSTRACT

A method and system for providing device management are shown. The system and method provides an installation of Mobile Enterprise Stack system for managing one or more devices and services associated with the one or more devices. The system and method further provide a process of managing configuration and management of the one or more devices in accordance with predefined rules and templates. The system and method further provides configuring an application data model comprising configuration template selected for each of the device, wherein the configuration template provides a resource operation for performing a task thereby providing management of device.

### RELATED APPLICATION

This present application claims priority to and is a Non-provisional Application of U.S. Provisional Patent Application Ser. No. 61/933,100 entitled “METHOD AND SYSTEM FOR DEVICE MANAGEMENT”, filed on May 14, 2014, which is incorporated herein by reference in their entirety for all purposes.

### TECHNICAL FIELD

The present disclosure in general, relates to a device and network management and more particularly to the management of devices (mobile or stationary) and services (physical or virtual) by a central management system (device management system).

### BACKGROUND

With evolution of mobile computing, organizations (like enterprises, operators, government organizations and so on) that use and run elements of mobile computing infrastructure (like physical mobile devices, virtualized mobile devices, software resources and infrastructure resources and so on) there is a requirement to manage and configure the elements of the mobile computing infrastructure.

In conventional mechanisms, mobile device management involves a centralized device management system operated by the owner of the devices being managed, and device management agents embedded into or installed onto those devices.

Other known methods manage devices through a periodic configuration and by monitoring activities of the devices at a regular interval. Further, there is a need to load multiple schemas to support and manage devices of different versions. The multiple schemas causes results in an increased load over a management system and may also impact performance of the management system.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates a network implementation of system for providing management of device, according to embodiments as disclosed herein;

FIG. 2 illustrates details of modules in the system for providing management of device, according to embodiments as disclosed herein;

FIG. 3 is a diagram that illustrates a high level exemplary architecture of the system, according to embodiments as disclosed herein;

FIG. 4 illustrates a structure of the system into multiple geographic or logical regions, according to embodiments as disclosed herein;

FIG. 5 illustrates a relationship between tenants and regions for device management, according to embodiments as disclosed herein;

FIG. 6 illustrates sub-components of the system, according to embodiments as disclosed herein;

FIG. 7 shows the domain model, i.e. the logical model of data and logic objects and their relationship, in UML notation according to embodiments as disclosed herein; and

FIG. 8 shows a flow chart for method for providing management of devices, according to embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

A method and system for providing device management are shown. The system and method provides an installation of Mobile Enterprise Stack system for managing one or more devices and services associated with the one or more devices. The system and method further provide a process of managing configuration and management of the one or more devices in accordance with predefined rules and templates. The system and method further provides configuring an application data model comprising configuration template selected for each of the device, wherein the configuration template provides a resource operation for performing a task thereby providing management of device.

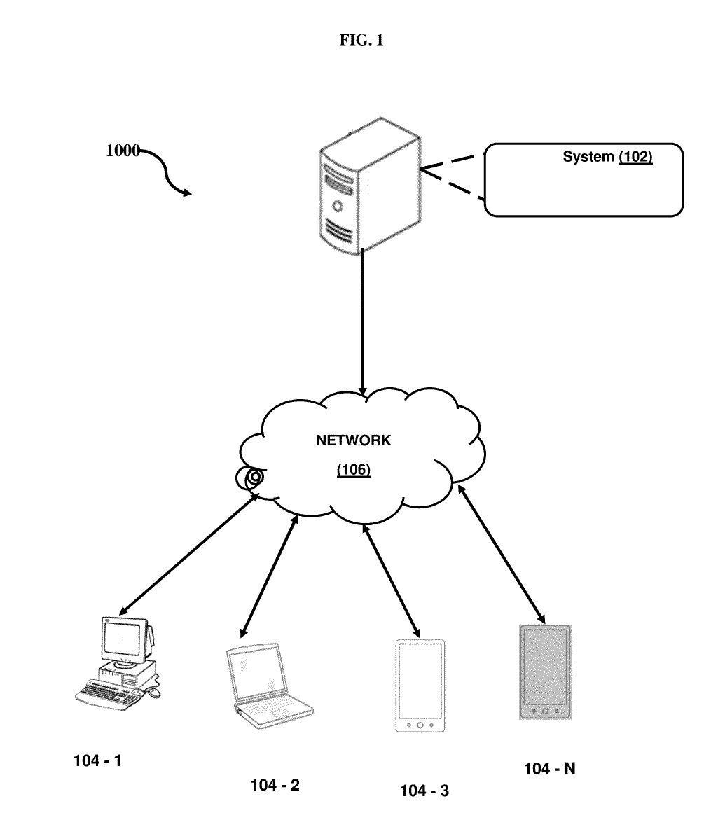

Referring to FIG. 1, a network implementation 1000 of the system 100 is shown. Although the present subject matter is explained considering that the system 100 may also be implemented as an application (to execute a set of instructions) on a server, it may be understood that the system 100 may also be implemented in a variety of computing systems, such as a laptop computer, a desktop computer, a notebook, a workstation, a server, a network server, an electronic device and the like. In one implementation, the system 100 may be implemented in a cloud-based environment. It may be understood that the system 100 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 100 through a network 106.

In one implementation, the network 106 may be a wireless network, a wired network or a combination thereof. The network 106 can be implemented as one of the different types of networks, such as intranet, local area network (LAN), wide area network (WAN), the internet, and the like.

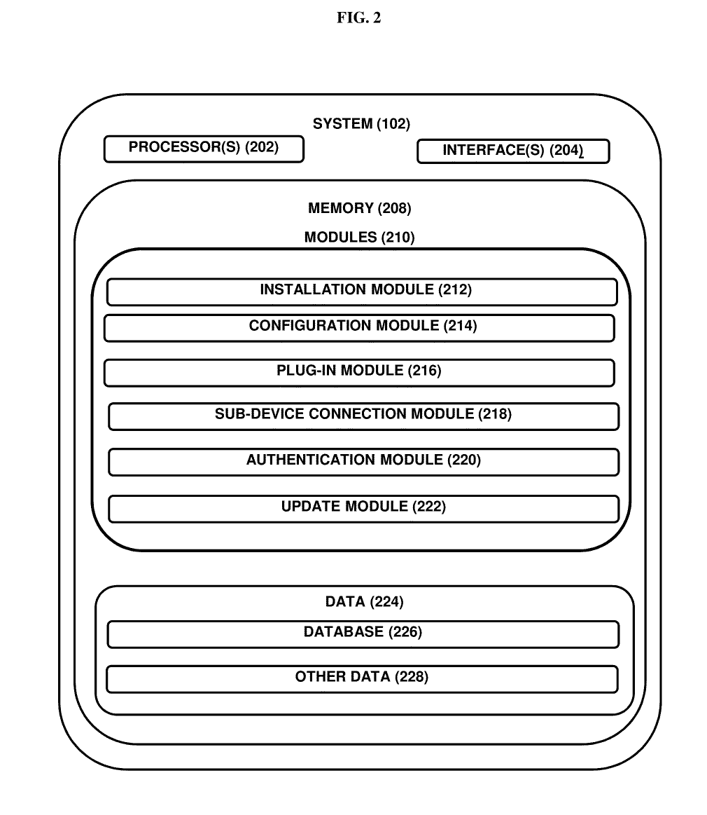

Referring to FIG. 2, the system 100 is illustrated in accordance with an embodiment of the present subject matter. In one embodiment, the system 100 may include at least one processor 202, an input/output (I/O) interface 204 (herein a configurable user interface), a memory 208. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 208.

The I/O interface 204 may include a variety of software and hardware interfaces, for example, a web interface, a graphical user interface, and the like. The I/O interface 204 may allow the system 100 to interact with a user directly or through the client devices 104. Further, the I/O interface 204 may enable the system 100 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The modules 210 include routines, programs, objects, components, data structures, etc., which perform particular tasks, functions or implement particular abstract data types. In one implementation, the modules 210 may include an installation 212, a configuration module 214, a plug-in module 216, a sub-device connection module 218, an authentication module 220 and an update 222. The modules 210 may include programs or coded instructions that supplement applications and functions of the system 102.

The data 224, amongst other things, serves as a repository for storing data processed, received, and generated by one or more of the modules 210. The data 224 may also include a database 226, and other data 228. The other data 228 may include data generated as a result of the execution of one or more modules 210.

The disclosed method and system provides a generalized solution of device and service management that differentiates from approaches known in the art.

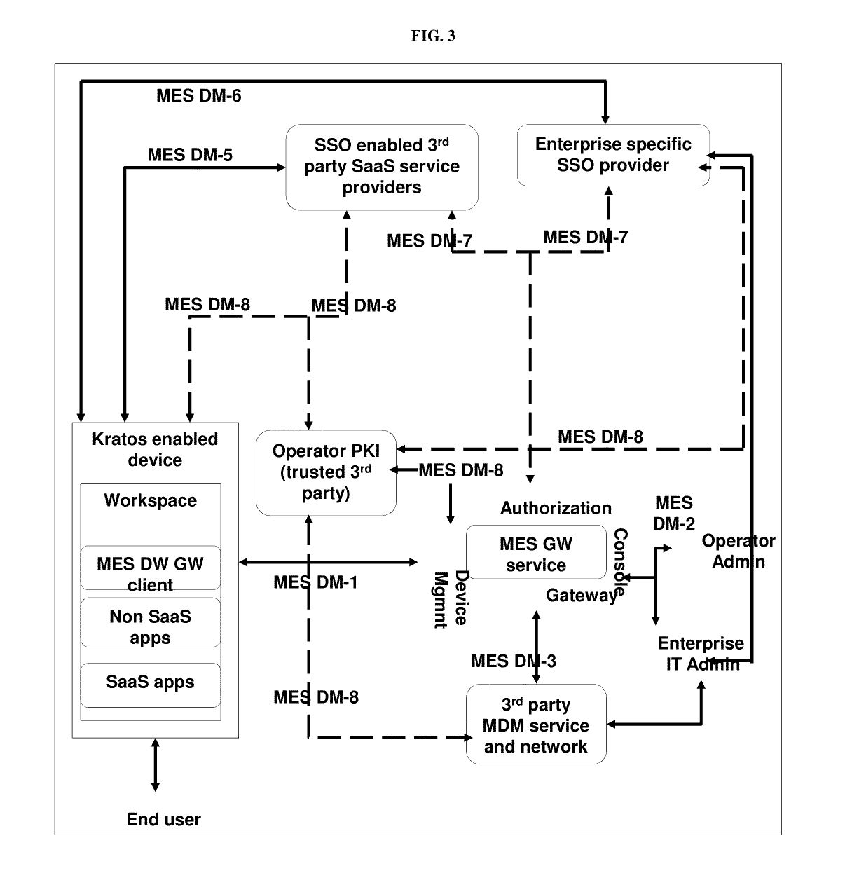

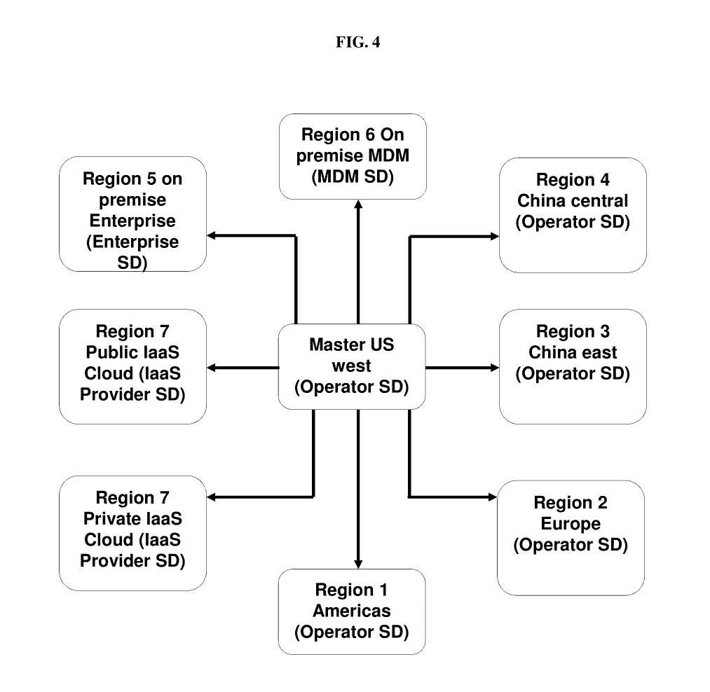

FIG. 3 is a diagram that illustrates a high level architecture of the system, according to embodiments as disclosed herein. The relationship of the architecture elements as defined in the following “Terminology” section is shown here in UML notation. FIG. 4 provides a structure of the system 102 into multiple geographic or logical regions

The system 102 comprises an installation module 212 (also referred as “Mobile Enterprise Stack System Instance”) configured to provide a particular installation of the Mobile Enterprise Stack system which may be managed by a Mobile Enterprise Stack System Operator to manage a set of entities (one or more devices) and to provide services to a set of customers associated with the one or more devices.

The service offer module (“Mobile Enterprise Stack System Operator”, not shown in drawings) is configured to allow a company or an organization to offer services. The service offer module communicate with the installation module (“Mobile Enterprise Stack System Instance”) to offer services. The Mobile Enterprise Stack System Operator may control all the aspects of the particular Mobile Enterprise Stack System Instance.

The configuration module 214 (“Mobile Device Management”) is configured to provide a process of managing the configuration and status of mobile devices (including device management, configuration management, application management and the management of other aspects) according to prescribed rules and policies of the organization (e.g. enterprise, government or non-government organization) that owns the managed resources or is entrusted with their management.

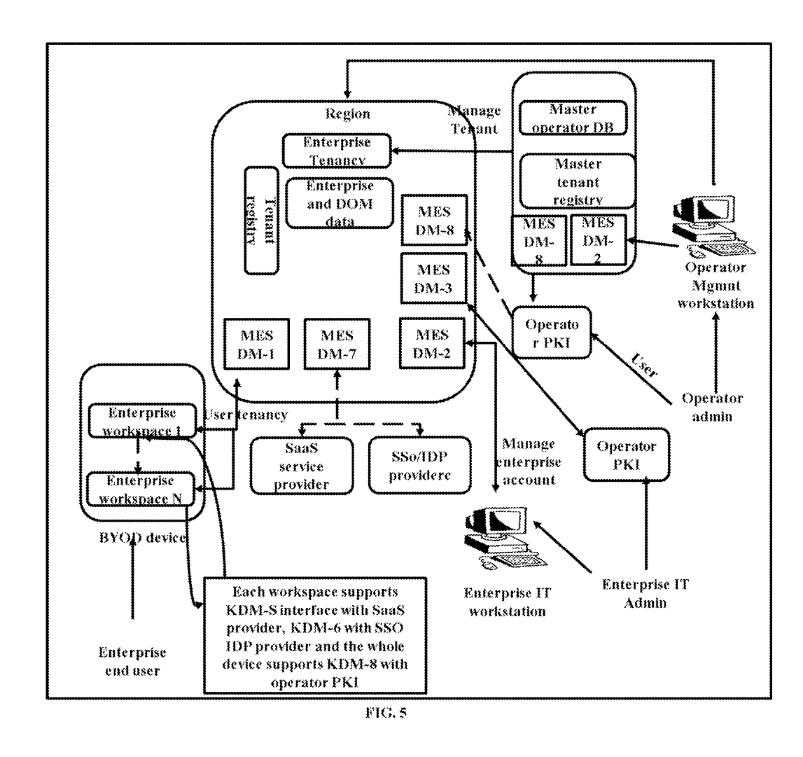

The task management module 216 (“Mobile Device Management System”) (MDM System) is communicatively coupled to the configuration module 214. The task management module 216 is configured to perform Mobile Device Management Tasks by way of a software system. The task management module 216 may be used by an enterprise to perform Mobile Device Management Tasks. The enterprise refer not only to an organization like an enterprise, but also to any entity intending to perform Mobile Device Management Tasks. “Tenants” may also refer to the enterprise for a fact that the system may be used by a multi-tenant (multi-enterprise) system. FIG. 5 shows a relationship between tenants and regions for device management.

The entities may include but are not limited to government organization, a non-government organization, service provider, and individual.

In an example embodiment, within an enterprise, an “Enterprise IT Admin” may perform the device management tasks through the task management module 216. The “Enterprise IT admin” refers to an authorized individual working as information technology (IT) administrator for the Enterprise, performing the Device Management tasks, such as configuring and administering enterprise services and infrastructure.

Further, an “Operator Admin” refers to an authorized individual working as administrator of the Mobile Enterprise Stack System Instance.

In an enterprise, an “end user” may refer to an employee or associate of the Enterprise, who may be an end user of the enterprise systems (and of the Mobile Enterprise Stack System).

The system 102 is configured to manage one or more electronic device (also referred as Managed entity or managed device). The electronic device comprises a mobile or stationary device or resource (such as PC, router, connected device, virtual device) which may be connected temporarily or permanently to a mobile network. Resource of the managed device or managed entity may be used to express policies, settings or to query current status information from the device. The Managed Resource may be generalized way for the system 102 to describe, store and communicate Device Management related concepts. The resource refers to an individually manageable name-value pair which corresponds to a managed items on the managed device. In a resource operation, the system 102 may perform an operation to change the value of resource or to query the resource.

In order to manage the device, a set of operations (Policy) are enforced by the device agent on the device. The set of operations may be expressed as set of resource operations and other meta-data. The set of operations describes a desired state or desired behavior of the managed device.

The device further includes “settings” which may not be enforced by the device agent. For example, the setting may be changeable by the device, or can be a reflection of the current device status.

An individual device may be connected to the system 102 for management. The individual device is a physical device and may be different from the managed device. The managed device may include physical device and virtual device. The individual device and managed device may be synonymously used. The individual device comprises a mobile phone, a tablet and alike.

In order to manage the individual device or managed device, the system 102 comprises a plug-in module 218 to use a “Third party MDM system” developed by a third party (offered in market) for the device management. The plug-in module 218 is also configured to integrate a “Mobile Enterprise Stack MDM Service” which refers to a light-weight MDM system and may be used as alternative or in conjunction with a third-party MDM system.

The device is managed by the system 102 through a “Mobile Enterprise Static Workspace”. The “Mobile Enterprise Static Workspace” refers to a virtualized securely isolated area on the device used for a purpose of management.

In an example embodiment, in order to allow the system 102 to manage one or more device (individual device or managed device), the end user may be required to follow a set of set of enterprise policies that allow enterprise employees (End Users) to use a device they personally own when accessing the enterprises resources. The End User device may need to accept and follow certain policies, or as long as the End User permits the enterprise to directly manage the parts of their device that connect to the enterprise services, hence aiding the adherence to the policies. Such type of working for management may be referred to as “Bring Your Own Device” (BYOD).

In an example embodiment, the desired state and configuration of managed entities are described by means of policies, configurations, templates and rules. Description of desired state are applied to a large number of physical and virtual managed entities. Description of the desired state helps to remove any discrepancy between current actual state of the device entity and the desired state of the device entity and allows the system 102 to take corrective actions.

The device may also include a client agent running on each device that is connected to a cloud service (Mobile Enterprise Stack Cloud service), which facilitates the creation and management of the Mobile Enterprise Stack Workspaces via a Mobile Enterprise Stack Gateway. The “Mobile Enterprise Stack Gateway” refers to a service that is supported by the System 102, residing in the cloud, which functions as gateway component between the third-party MDM System and the system 102 for management of device. A gateway component that is used between the system 102 and a third-party MDM system, whenever an enterprise uses this may manage the devices. The client agent herein may be referred to as “Mobile Enterprise Stack Device Client” (MES DM GW Client).

To provide an efficient management, the system 102 includes a full set of interfaces to manage distributed networked entities are moved to an intermediate gateway that sits in the ‘cloud’ (network) rather than on the physical devices.

The gateway is able to intelligently manage and communicate with the entrusted managed entities without burdening the system 102. In this way it is possible to achieve a multi-tenant setup whereby multiple tenants (e.g. companies or government organizations) are able to manage a set of managed entities in a secure and isolated fashion while leveraging the same cloud-based infrastructure. In this way scalability and reliability of the system is achieved without overburdening of the managed entities and the cloud-based gateway.

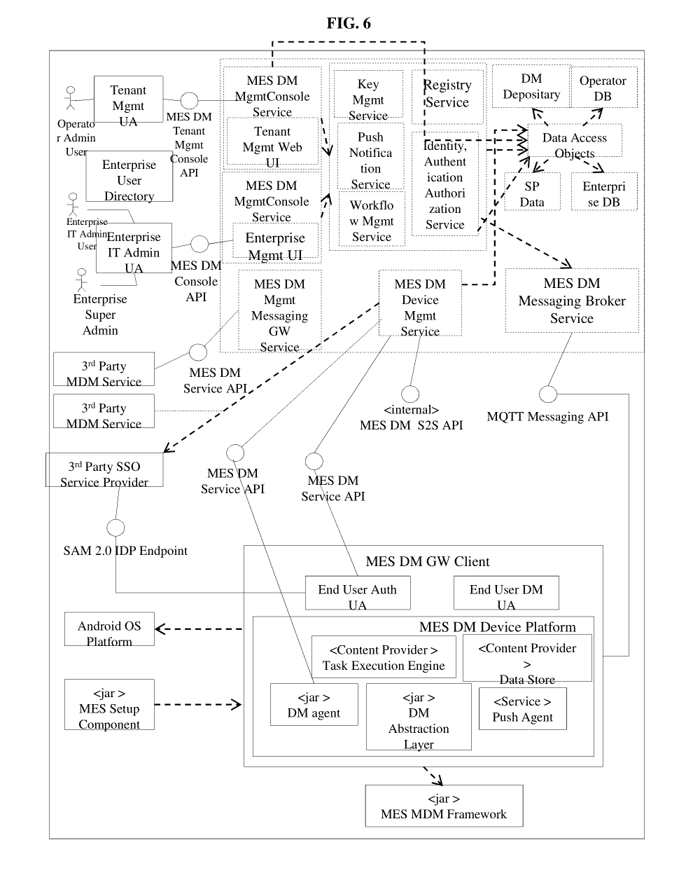

In accordance with FIG. 6, the system 102 further comprises a sub-device connection module 218 (“Mobile Enterprise Stack Device MDM Framework”) to include subsystem of device-side services and components which can allow for the local management of the Mobile Enterprise Stack workspace by the MDM. By default; this can be used by the Mobile Enterprise Stack Device Client to manage one or more Mobile Enterprise Stack Workspaces on the device. As an exception, a native local MDM client may also use this framework to manage the Mobile Enterprise Stack workspace that is not connected to the Mobile Enterprise Stack Gateway.

The third party may provide an “ID Management Provider” which refers to a service related to Identity Management, provided by a third-party set up for a given enterprise. The system 102 also uses two subsystems i.e., an authentication provider and a directory service.

The system 102 further comprises an authentication module 220 (“Authentication Provider”) to provide a service (generally provided by a third-party or by a software package installed within an enterprise) that may authenticate the device (a user of the device) for this enterprise.

In an example embodiment, the “Single Sign-On” (SSO) Provider” refers to a specific type of Authentication Provider that offers SSO (Single Sign-On) capability. The SSO provider provides i.e. the capability to maintain a single session of authentication that can be shared by a number of clients (e.g. applications on a device), so that the End User does not have to re-authenticate with every single client.

The “Directory Service” refers to a service that provides a list of enterprise users, their email addresses, their primary mobile phone numbers, and their groups and so on.

In one example embodiment, the system 102 further comprises one or more applications for device management. The system 102 uses a “Software as a Service” (SaaS) App refers to an application that uses a “Software As a Service” model and hence connects to the back-end of the Service Provider, and which often requires authentication and authorization to use the service of the service provider, in order to function fully.

In an example embodiment, the system 102 comprises following:

A Rest API that provides CRUD operations on the system's REST resources.

(b) A Device management service that implements the business logic.

(c) A Rules engine that runs the rules from different sources (Enterprise IT admin, Mobile Enterprise Stack admin, Business rules) and arrives at a conclusion on the policies to be pushed to a particular user/device.

(d) Application data that is split among the SQL and NOSQL databases.

(e) Authentication and authorization module—that may be used by the device and the Enterprise console to have secure access to the system 102.

(f) Push notification service that pushes the policies to individual devices.

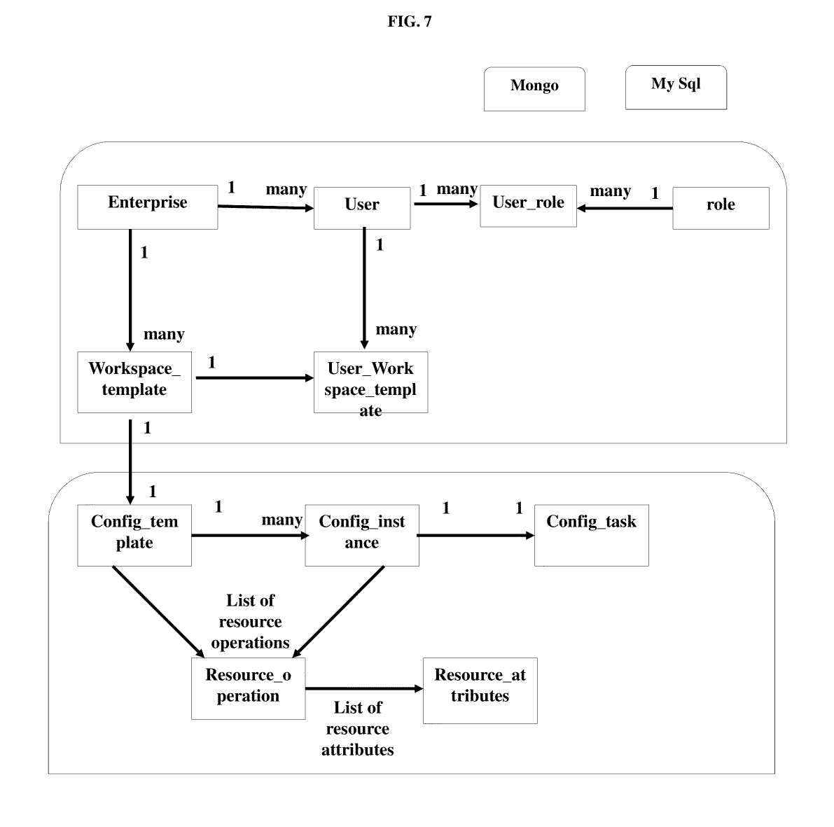

In accordance with an embodiment, FIG. 7 shows the domain model, i.e. the logical model of data and logic objects and relationship between the data and logic objects, in UML notation provided by the system 102 through the configuration module 214.

The central part of the application data model (domain model) includes a configuration template. The configuration template comprises resource operations for each group of users. The association of the template with the user is controlled through an enterprise console. When a particular user on boards a configuration instance of the template, he/she is associated with the configuration template created for management of device that user. This instance may be updated further through the enterprise console. The instance creation and instance updates both result in a task/job queued to be pushed to the user's device through the task management module 216.

The configuration template, configuration instance and the configuration task are stored as separate documents by a storage module. The configuration template is derived from a JSON schema that is predefined and versioned. The schema consists of a list of predefined resource operations that are supported on the device for a particular version. The JSON structure that results out of the derivation of configuration template form the schema and further making a copy of the template to form an instance, serves as a protocol between the device and the backend. The JSON structure (instance) also serves as a snapshot of the device status with respect to the interested resource operations.

REST resources and operations offered by the management service toward the Enterprise Console are outlined below:
Resource: template
   GET—/templates—Fetch a list of templates for a given enterprise
   GET—/templates/{templateId}—Fetch the particular template
   POST—/templates—Add a template t an enterprise
   PUT—/templates/{templateId}—Update the particular template
   DELETE—/template/{templateId}—Delete the particular template
Resource: instance
   GET—/instances—Fetch a list of instances for a given workspace template
   GET—/instances/{instanceId}—Fetch the particular instance
   PUT—/instances/{instanceId}—Update the particular instance
Resource: workspace template
   GET—/workspaces/{enterpriseId}—Fetch a list of workspace templates for a given enterprise
Resource: user-workspace template
   POST—Add a user workspace template association using a schema type
   PUT—Update the user workspace template association
Resource: schema
   GET—Fetch a schema of a given schema type
      Operations Offered Toward Managed Devices: Resource: task
   GET—/tasks—Fetch a configuration instance associated with a task/task token
   PUT—/tasks—Update the status for an instance and compliances for each resource operation, for a task/task token

Rules are used for further abstraction of defining the desired behavior of the system 102. There are cases in the application where an inference engine may be efficient. An example of an interrelated decision case is a selection of a particular template for a particular user. In this case it helps to use a rules engine to arrive at a suitable template for the user. This may be a combination of templates that forms a composite template based on the result of the rules applicable to the user. As the sequential evaluation approach may not be efficient for such cases, an inference engine may be used that uses the popular Rete algorithm like the JBoss Drools.

The Device Management Service may include business logic part of a policy management module (not shown in Figure). This tackle the policy management problem, a template-instance mechanism is used which confirms to the prototype design pattern. The template here serves as the prototype class.

### Creation of Resources Happens as Follows:

Configuration templates are created from the enterprise console, based on the schema. The enterprise console UI fetches a particular version of the schema and presents it to the console user who decides to choose parts or all of it to create a new template for a group of her/his enterprise users.

A workspace template in MySQL is created before the template is created and the workspace template Id is used as a reference in the configuration template.

Configuration instances for users may be created when the users are on board. When the user logs in using the Gateway client on the device, if there exists no instance for the unique device Id, a new one is created by making a copy of the template that is applicable to the user.

User-workspace template is created from the enterprise console when the console user associates a workspace template with a particular user.

Configuration task is created from four causes—

(1) When the user is on boards. Along with the instance a task is created that references the instance created for that user and is queued to be pushed onto the user's device.

(2) When the configuration template is updated.

(3) When the configuration instance is updated.

(4) When the user-workspace template is updated.

### Update of Resources Happens as Follows:

Configuration template is updated through the enterprise console by an update module 222 of the system 102. When a template is updated, each of the instances that refer to this template is also updated with the new set of resource operations from the template. Then for each updated instance, a task is created (2) and is queued to be pushed onto the user's device. Note that any updates to the configuration template override the existing resource operations and their compliance in each of the instances.

Configuration instance is updated from two causes—Firstly through the enterprise console. This is when the console user decides to change a resource operation for a particular user (ad-hoc). When such an update happens, a task is created (3) and is queued to be pushed onto the user's device. Note that each update to the instance creates a separate task that is queued to be pushed onto to the device. Secondly when the device updates the instance with the status and compliance for each of the resource operation. Note that this update doesn't create a task.

User-workspace template is updated through the enterprise console when the console user decides to change the template that was associated with a particular user. This can then call for an update of the configuration instance of that user to have the new set of resource operation from the new template chosen. Then a task is created (4) and is queued to be pushed onto the user's device.

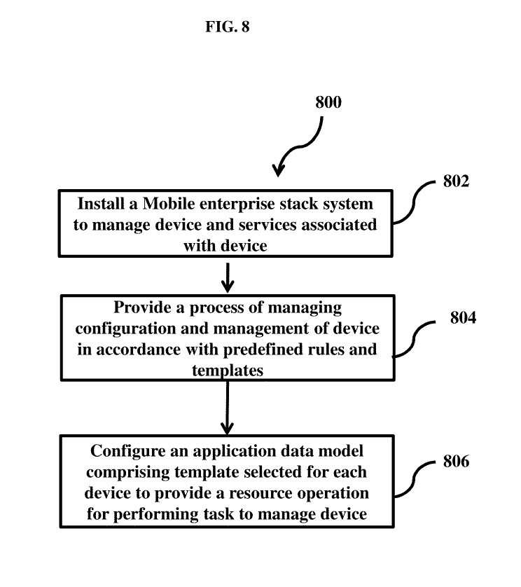

In accordance with an embodiment, FIG. 8 shows a method 800 for providing device management through system 102.

At step 802, the method 800 provides an installation of the Mobile enterprise stack system to manage one or more devices and services associated with the one or more devices. The installation may be performed through the installation module 212.

At step 804, the method 800 provide a process of managing configuration and management of the one or more devices in accordance with predefined rules and templates.

At step 806, the method 800 provides to configure an application data model comprising configuration template selected for each of the device. The configuration template provides a resource operation for performing a task thereby providing management of device. The configuration may be provided by the configuration module 214.

Description of method 800 is similar to as described for system 102.

The embodiments disclosed herein can be implemented through at least one software program running on at least one hardware device and performing network management functions to control the elements. The elements shown in FIGS. 3 to 7 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system for providing management of device, the system comprising:
a processor;
a memory coupled to the processor, wherein the memory comprises a plurality of modules, wherein the plurality of modules are configured to:
install a Mobile enterprise stack system to manage one or more devices and services associated with the one or more devices;
provide a process of managing configuration and management of the one or more devices in accordance with predefined rules and templates; and
configure an application data model comprising configuration template selected for each of the device, wherein the configuration template provides a resource operation for performing a task thereby providing management of device.

2. The system of claim 1, wherein one or more device management tasks are performed in accordance with the resource operation for device management.

3. The system of claim 1, wherein the plurality of modules are configured to:
integrate one or more third party system for device management.

4. The system of claim 1, wherein the predefined policies, configurations, templates and rules provides a description of desired state of the device.

5. The system of claim 1, wherein the system manages the device through a mobile enterprise stack gateway.

6. The system of claim 1, wherein the plurality of modules are configured to include at least one of a subsystem of device side services and components, wherein the at least one of a subsystem of device side services and components provides a local management of mobile enterprise stack workspace of device.

7. The system of claim 1, wherein the plurality of modules are configured to:
authenticate the device for the enterprise; and
provide at least one list of enterprise users, email addresses of enterprise users, primary mobile phone numbers, and groups of enterprise users.

8. The system of claim 1, wherein the plurality of modules are configured to:
store at least one of a configuration template, configuration instance and the configuration task as separate documents, wherein the configuration template is derived from a JSION schema.

9. The system of claim 1, wherein the configuration template is updated by an update module, wherein the update comprises update of resource operations.

10. A method for providing management of device, the method comprising:
installing a Mobile enterprise stack system to manage one or more devices and services associated with the one or more devices;
providing a process of managing configuration and management of the one or more devices in accordance with predefined rules and templates; and
configuring an application data model comprising configuration template selected for each of the device, wherein the configuration template provides a resource operation for performing a task thereby providing management of device.

11. The method of claim 10, wherein one or more device management tasks are performed in accordance with the resource operation for device management.

12. The method of claim 10, further comprises:
integrating one or more third party system for device management.

13. The method of claim 10, wherein the predefined policies, configurations, templates and rules provides a description of desired state of the device.

14. The method of claim 10, wherein the device is managed through a mobile enterprise stack gateway.

15. The method of claim 10, further comprises:
authenticating the device for the enterprise; and
providing at least one list of enterprise users, email addresses of enterprise users, primary mobile phone numbers, and groups of enterprise users.

16. The method of claim 10, further comprises:
storing at least one of a configuration template, configuration instance and the configuration task as separate documents, wherein the configuration template is derived from a JSION schema.

17. The method of claim 10, wherein the configuration template is updated by to provide an update of resource operations.

18. A non-transitory computer readable medium storing a program causing one or more computers to provide management of device, the management of device comprising:
installing a Mobile enterprise stack system to manage one or more devices and services associated with the one or more devices;
providing a process of managing configuration and management of the one or more devices in accordance with predefined rules and templates; and
configuring an application data model comprising configuration template selected for each of the device, wherein the configuration template provides a resource operation for performing a task thereby providing management of device.
